(19) United States
(12) Patent Application Publication
(10) Pub. No.: US 2006/0016348 A1
(43) Pub. Date: Jan. 26, 2006

(54) Griddle top for portable field feeding

(76) Inventor: Robert S. Babington, McLean, VA (US)

Correspondence Address: CONNOLLY BOVE LODGE & HUTZ LLP, SUITE 800, 1990 M STREET NW, WASHINGTON, DC, 20036-3425, US

(21) Appl. No.: 10/897,031

(22) Filed: Jul. 23, 2004

(51) Int. Cl. A47J 37/10

(52) U.S. Cl. 99/422

(57) ABSTRACT

A griddle top for portable field feeding units. A rectangular enclosure has a top surface forming a cooking surface, and a plurality side surfaces. The enclosure is open along a bottom thereof. A grease trough along one edge of the top surface has a discharge opening for discharging grease which accumulates on the cooking surface. A receptacle supported below a discharge opening in the grease trough accumulates the grease produced during cooking operations. The rectangular enclosure is supported above a heat source by a plurality of legs. A heat diverting mass is centrally located on the underside of the cooking surface which equalizes heat distribution from the heat source along the underide of the cooking surface, equalizing the temperature distribution across the cooking surface preventing warping of the cooking surface.

### BACKGROUND OF THE INVENTION

The present invention relates to equipment for field feeding large numbers of people. Specifically, a griddle top is disclosed which can be used with any portable heat source to grill food.

In large scale field feeding applications, such as are found in the military or in emergency disaster feeding operations, it is necessary to establish a rapidly deployable cooking device. Usually these operations are carried out in locations where there are no permanent facilities, very few utilities and only a single fuel available such as diesel. Babington Enterprises, Inc. has made a number of devices useful for field feeding including a Tray Ration Heating System described more particularly in U.S. Pat. No. 5,975,071, a multi fuel powered burner for field cooking shown in U.S. Pat. No. 6,176,233 and a portable field sanitation unit used for cleaning cooking utensils, described more particularly in U.S. Pat. No. 6,453,487. These facilities provide for broiling, baking and boiling liquids in a field environment. The powered multi fuel burner shown in U.S. Pat. No. 6,176,233 generates heat from diesel fuel, or any other distillate fuel, which can be installed in U.S. Army M-59 field feeding cabinet or other cooking stove. Each of the foregoing Babington Enterprises, field feeding appliances utilize a common burner, also manufactured by Babington Enterprises, which has a variable firing rate and can use any distillate fuel.

The multi-fuel burner for field cooking supplies heat which can be used in various cooking applications. However, a satisfactory grilling application has not been heretofore developed. The powered multi-fuel burner puts out so much heat, in the nature of 60,000 BTU, at temperatures up to 2,000°, that any standard grill top surfaces would likely warp or fracture because of the intense heat which is localized at the top of the multi-fuel burner fire box.

The present invention provides a grilling appliance which is both portable, and which can sustain the high temperatures which are encountered using the empowered multi-fuel burner as a heat source. Additionally, the grilling appliance has a high heat recovery rate when cooking frozen foods.

### SUMMARY OF THE INVENTION

A griddle top for a portable field feeding unit is provided having a cooking surface made from a high temperature material. A rectangular enclosure has a top surface which forms a cooking surface for the griddle. Heat from a portable heat source is directed along the underside of the top surface through an opening in the bottom of the rectangular enclosure. The side surfaces each have openings for discharging the heated air directed along the under side of the surface from the heat source. One edge of the top surface has a grease trough for accumulating grease which forms during cooking and discharging the grease trough an opening. A heat diverting mass is centrally located on the under side of the cooking surface. The diverting mass enhances the heat distribution across the under side of the cooking surface by keeping the temperature of the central portion of the cooking surface from rising significantly higher than the remaining portion of the cooking surface. The heat diverting mass also prevents warpage of the cooking surface.

In accordance with a preferred embodiment of the invention, a grease receptacle is located under the grease trough to catch the grease which forms during cooking. The grease trough is recessed with respect to the cooking surface and has a discharge opening where accumulating grease may flow. The receptacle supported beneath the grease trough may be a drawer which can be expeditiously emptied.

### BRIEF DESCRIPTION OF THE DRAWINGS

FIG. 1 is an isometric view of the griddle top positioned over a multi fueled powered heat source.

FIG. 2 illustrates the drawer which is used to accumulate grease during cooking.

FIG. 3 is a top view of the griddle top.

FIG. 4 is a bottom view of the griddle top of FIGS. 1-3.

FIG. 5 is a section view of the griddle top of FIGS. 1-4.

### DETAILED DESCRIPTION OF THE PREFERRED EMBODIMENT OF THE INVENTION

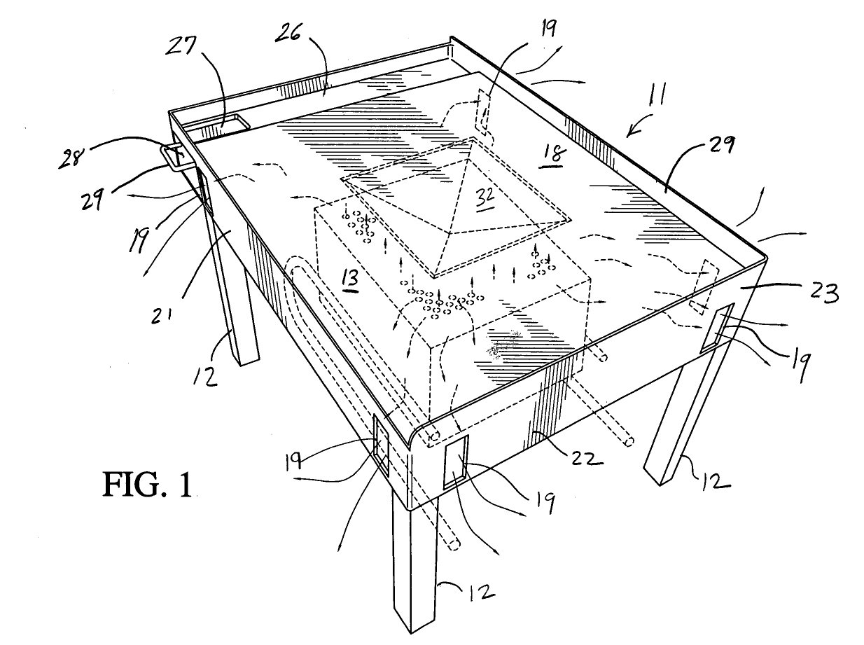

Referring now to the FIG. 1, the griddle top 11 is supported by a plurality of integral legs 12 over a heat source 13. Heat source 13 may be a thermostatically controlled multi-fuel powered burner as disclosed in U.S. Pat. No. 6,176,233. The apertured surface of the multi-fuel burner 13 firebox supplies a heat temperature of approximately 2,000° F. and 20,000-60,000 BTUs to the underside of the cooking surface 18 of griddle top 11. Heat is diverted across the underside of cooking surface 18, and exits through a plurality of openings 19 along the lateral surfaces 21, 22 and 23 of the griddle top 11.

A grease trough 26 is located at one edge of the cooking surface 18 and vertically recessed from cooking surface 18. During a cooking operation, grease accumulating along the surface of the cooking surface 18 may be pushed with a spatula or other cooking tool into the grease trough 26.

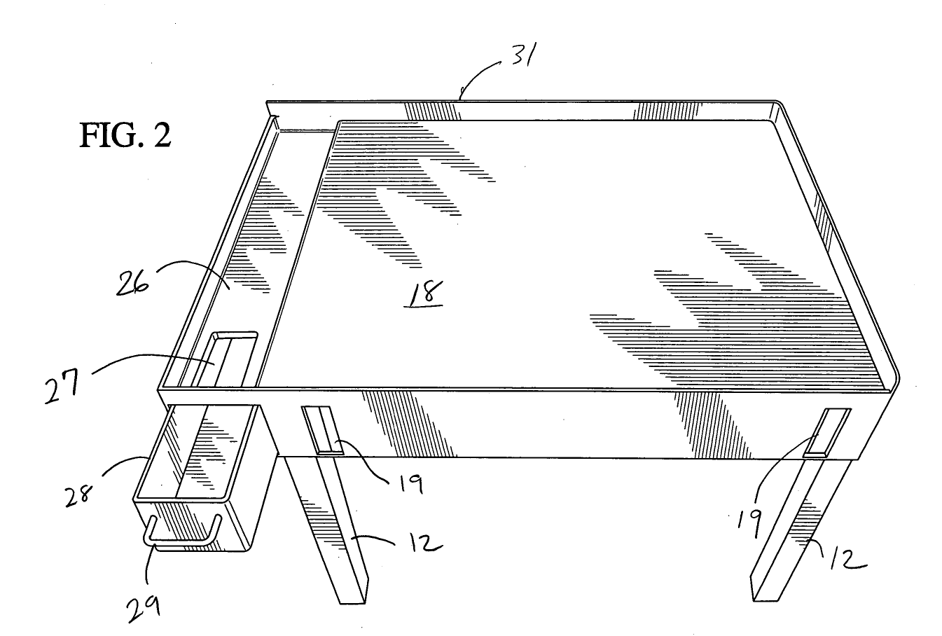

A discharge opening 27 is located at one end of trough 26 which permits the cooking grease to flow into a receptacle shown as drawer 28 supported below the grease trough 26. The drawer 28 may be emptied by pulling on the handle 29, which pulls the drawer horizontally from its' supported position under grease trough 26 permitting it to be emptied. FIG. 2 illustrates the drawer 28 being removed from the griddle top 11 and discarding the collected grease. A vertical ridge 31 is located around the periphery of the griddle top 11 so that grease is confined to the top surface of the griddle top.

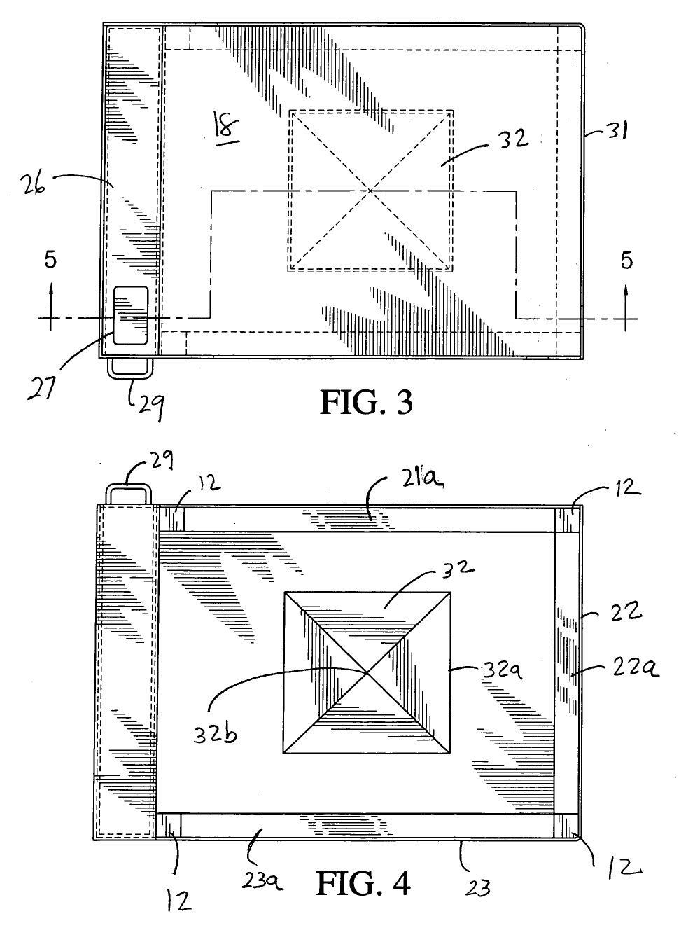

FIGS. 3 and 4 are a top and bottom view of the griddle top. The griddle top rectangular enclosure is opened on the bottom thereof to receive heat from the multi fueled power burner 13. The bottom edges 21a, 22a, and 23a of the lateral surfaces 21-23 of the rectangular enclosure are shown bent or curved at an acute angle with respect to the underside cooking surface 18. This results in an improved heating efficiency with hot gases being directed back into the rectangular enclosure and away from any personnel operating the system. A heat diverting mass 32 is shown welded to the underside of top surface 18. The heat diverting mass 32 is centrally located along the underside of cooking surface 18, and has four sides forming a pyramid structure. The base of the pyramid structure 32a is welded to the underside of cooking surface 18, and the pyramid extends along an axis perpendicular to the cooking surface 18 to a point 32b.

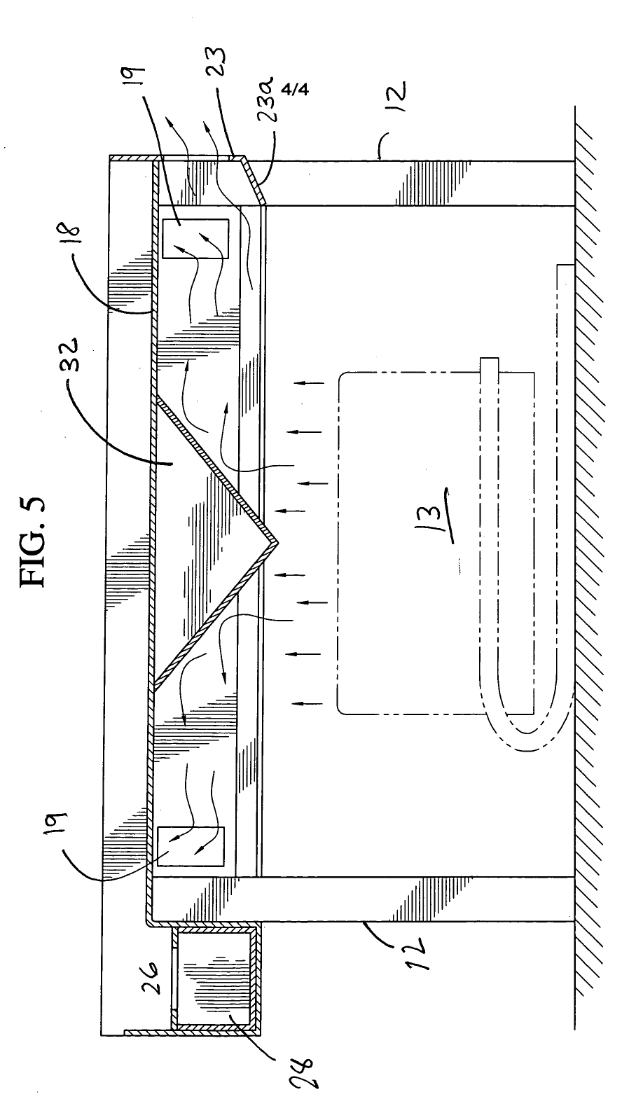

FIG. 5 shows how during a cooking operation, heat flows vertically from the top surface of the powered multi-fuel burner firebox 13 which is generally aligned with the heat diverting mass 32. The diverting mass 32 tends to force the heat laterally, towards the four corners of the rectangular enclosure where it exits trough openings 19. The diversion of heat flow away from the center towards the openings 19 tends to equalize the temperature distribution across the cooking surface. This results because the center of the cooking surface, while located over the heat source, is prevented from overheating by the diverting mass avoiding a surface temperature distribution which is significantly uneven. As a result of the even temperature distribution, the stress induced in cooking surface 18 does not permanently warp the surface as well as break any welds which have been made to cooking surface 18.

The griddle top in accordance with the preferred embodiment is made from a hastalloy steel, which has a high temperature resistant properties. The griddle top has a size and weight which permits it to be set up, used and stored by single individual. The griddle top has a high heat recovery when grilling large quantities of frozen food. The large heat mass of the steel rectangular enclosure and heat diverting mass maintains the temperature of the griddle top surface substantially constant under all cooking conditions.

The foregoing description of the invention illustrates and describes the present invention. Additionally, the disclosure shows and describes only the preferred embodiments of the invention in the context of a griddle top for portable field feeding, but, as mentioned above, it is to be understood that the invention is capable of use in various other combinations, modifications, and environments and is capable of changes or modifications within the scope of the inventive concept as expressed herein, commensurate with the above teachings and/or the skill or knowledge of the relevant art. The embodiments described hereinabove are further intended to explain best modes known of practicing the invention and to enable others skilled in the art to utilize the invention in such, or other, embodiments and with the various modifications required by the particular applications or uses of the invention. Accordingly, the description is not intended to limit the invention to the form or application disclosed herein. Also, it is intended that the appended claims be construed to include alternative embodiments.

What is claimed:

1. A griddle top for a portable field feeding unit comprising:
an enclosure having a top surface forming a cooking surface, side surfaces and open along a bottom thereof, said side surfaces having openings for discharging heat directed along the underside of the top surface;
a grease trough along one edge of said top surface for accumulating grease which forms on said cooking surface;
a heat diverting mass centrally located on the underside of said cooking surface for enhancing heat distribution across the underside of said cooking surface; and
support means for supporting said enclosure above a portable heat source whereby said cooking surface is heated to a temperature for cooking.

2. The griddle top according to claim 1, wherein said heat diverting mass is shaped as a pyramid with its base connected to said cooking surface underside, said pyramid having an axis perpendicular to said cooking surface.

3. The griddle top for a portable field feeding unit according to claim 1, wherein said top surface and grease trough have a vertically extending peripheral edge.

4. A griddle top for a portable field feeding system comprising:
a cooking surface having a vertically extending periphery, said surface including along one edge thereof a recessed grease trough having a grease discharge opening, and having a heat diverting mass centrally located on the underside thereof;
a receptacle supported beneath said grease trough along the length of said one edge for catching grease flowing from said opening; and
a plurality of legs supporting said cooking surface above a portable heat source, wherein heat is transferred to the underside of said cooking surface heating said cooking surface and diverted towards the corners of said cooking surface by said heat diverting mass.

5. The griddle top according to claim 4, wherein said heat diverting mass is shaped as a pyramid with its base connected to said cooking surface underside.

6. The griddle top according to claim 4, wherein said cooking surface forms the top of a rectangular enclosure open along the bottom thereof to receive heat from the portable heat source, said rectangular enclosure having along sidewalls thereof openings to facilitate heat flow across the surface of said cooking surface underside.

7. A griddle top for a portable field feeding unit comprising:
a rectangular enclosure having a top surface forming a cooking surface, a plurality of side surfaces and open along a bottom thereof, said side surfaces having openings for discharging heat directed along the underside of the top surface;
a grease trough along one edge of said of top surface having a discharge opening for discharging grease which accumulates on said cooking surface;
a receptacle supported below said discharge opening for accumulating and disposing of grease flowing through said discharge opening; and
support means for supporting said enclosures above a portable heat source whereby said cook surface is heated to a temperature for cooking.

8. The griddle top for a portable field feeding unit according to claim 7, further comprising a heat diverting mass centrally located on the underside of said cooking surface for enhancing heat distribution across the underside of said cooking surface.

9. The griddle top for a portable field feeding unit according to claim 7, wherein said grease trough is recessed with respect to said cooking surface.

10. The griddle top for a portable field feeding unit according to claim 7, wherein said receptacle is a drawer supported for horizontal movement under said discharge opening.
